(19) United States
(12) Patent Application Publication
(10) Pub. No.: US 2010/0118992 A1
(43) Pub. Date: May 13, 2010

(54) COMMUNICATION PROCESSING SYSTEM, OFDM SIGNAL TRANSMITTING METHOD, OFDM TRANSMITTER, OFDM RECEIVER, AND CONTROL STATION

(75) Inventor: Shigeo TERABE, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/480,080

(22) Filed: Jun. 8, 2009

(30) Foreign Application Priority Data
Nov. 7, 2008 (JP) P2008-286538

(51) Int. Cl. H04L 27/28

(52) U.S. Cl. 375/260

(57) ABSTRACT

An OFDM signal transmitting method includes multiplying a first data channel signal multiplied by a scrambling code by a transmission power boost value notified in advance from one or more control stations that control OFDM transmitters included in the same service area to all the OFDM transmitters included in the service area; generating, in a time symbol based on time symbol information from one of the one or more control stations, an OFDM signal by OFDM-modulating a second data channel signal and a pilot channel signal multiplied by scrambling codes and the first data channel signal multiplied by the transmission power boost value, the OFDM signal being a signal in which a macro diversity signal and a non-macro diversity signal are frequency-division-multiplexed; and transmitting the OFDM signal.

### BACKGROUND OF THE INVENTION

1. Field of the Invention

The present invention relates to communication processing systems, orthogonal frequency division multiplexing (OFDM) signal transmitting methods, OFDM transmitters, OFDM receivers, and control stations. In particular, the present invention relates to a communication processing system, an OFDM signal transmitting method, an OFDM transmitter, an OFDM receiver, and a control station capable of transmitting and receiving OFDM signals.

2. Description of the Related Art

Multicast/broadcast services (MBS) have been standardized. According to the IEEE802.16e standard, by using a cellular network, a multicast/broadcast service allocates a common physical resource to all users (i.e., mobile stations MS owned by the respective users) present in a cell area, and delivers high-quality video streaming, news information, or commercial films. Communication using MBS is referred to as “MBS communication”. In contrast, communication in which a base station allocates an individual physical resource to one mobile station MS is referred to as “unicast communication”. In the case of MBS communication, the same multicast/broadcast data is transmitted from one or more base stations. A group of base stations that perform MBS communication is defined as a “multicast/broadcast service area”. Generally, as compared to a broadcast service station, one base station included in a multicast/broadcast service area covers a smaller area and has a smaller cell size. Therefore, it is possible to provide location-based information services chat are available only in a limited area.

It is also possible to change the area for each MBS channel. For example, music information and news information may be broadcasted in a large area, while shop advertisements and local news may be broadcasted in a small area. Both MBS channels can be multiplexed, so that one user (i.e., the user's mobile station MS) can select and receive an MBS channel receivable at its geographical location.

Generally, to ensure stable unicast communication even during maximum use of frequency resources for unicast communication, an operator (i.e., a cellular phone carrier) arranges base stations such that certain margins are left with respect to the installed capacities of the base stations. However, the base stations arranged in this manner do not transmit unicast signals (non-macro diversity signals) at maximum transmission power using the margins of transmission power. This is because in unicast transmission, an increase in transmission power of base stations may cause an increase in interference between base stations, and therefore the throughput of the entire system may level off. In particular, for example, in an urban environment where base stations are closely arranged in a limited area, even if all frequency resources are allocated to the mobile stations MS, certain margins may be left with respect to the maximum transmission power of the base stations.

On the other hand, MBS communication assumes a multi-cell multicast-broadcast single frequency network (MBSFN) environment. In this environment, from base stations present in a multicast/broadcast service area in which the same MBS is performed, the same MBS data is transmitted using the same time-frequency resources. Therefore, each mobile station MS present in the multicast/broadcast service area can RF-combine MBS signals (macro diversity signals) from base stations and receive the resulting signal. Thus, since an increase in transmission power from the base stations present in the multicast/broadcast service area does not cause interference between base stations, it is possible to improve the throughput of the entire MBS system. This is because if the transmission power of base stations increases, a more efficient modulation method and a more efficient coding rate can be used in MBS communication.

Therefore, if a margin of transmission power in unicast communication can be allocated to MBS communication, it is possible to enhance the use efficiency of frequencies. Thus, using remaining resources makes it possible to reduce cost per bit and provide services at low cost.

According to http://wirelessman.org/tgm/contrib/C80216m-08_{—}1047rl.doc, to allocate a margin of transmission power in unicast communication to MBS communication, a method in which a non-macro diversity signal and a macro diversity signal are multiplexed by frequency division multiplexing (FDM) or space division multiplexing (SDM) has been proposed (see, e.g., http://wirelessman.org/tgm/contrib/C80216m-08_{—}1047rl.doc).

As illustrated in FIG. 1A, if unicast channels and MBS channels are allocated by time division multiplexing (TDM), transmission power for MBS communication can be set to maximum transmission power of each base station. However, a margin of transmission power in unicast communication cannot be provided to MBS communication. That is, in the case of FIG. 1A, there is unused transmission power associated with unicast communication in the duration from one first to sixth time symbols, whereas there is no unused transmission power for MBS communication in the duration from the seventh to twelfth time symbols. Therefore, averaging the transmission power in the duration from the first to twelfth time symbols gives unused transmission power for each time symbol.

On the other hand, as illustrated in FIG. 1B, if unicast communication and MBS communication are multiplexed by FDM or SDM, transmission power in MBS communication can be boosted by using a margin of transmission power in unicast communication in each time symbol. That is, there is no unused transmission power in the ease of FIG. 1B, since unused transmission power associated with unicast communication can be provided to MBS communication in any of the first to twelfth time symbols. It is thus possible to make maximum use of resources in the duration from the first to twelfth time symbols. Therefore, it is possible to improve the throughput of the entire MBS system without degrading the throughput of unicast communication.

In embodiments of the present invention, the term “time symbol” refers to a unit on the time axis. As illustrated in FIG. 1A and FIG. 1B, time symbols are used when each symbol is transmitted using a plurality of subcarriers.

There are the following two challenges in controlling boosting of transmission power for MBS channels.

The first challenge is that it is necessary to consider variations in transmission power in unicast communication. Specifically, since scheduling for MBS communication involves cooperation of a plurality of base stations, it is necessary that the scheduling be performed several time symbols before scheduling for unicast communication. If a margin of transmission power in unicast communication is temporally substantially constant, scheduling for MBS communication is performed, by considering this substantially constant margin of transmission power, on time symbols to which boosting of transmission power in MBS communication is to be applied.

However, if a margin of transmission power in unicast communication varies, it is difficult to detect a margin of transmission power in unicast communication in time symbols to which boosting of transmission power in MBS communication is to be applied. Therefore, in practice, it is necessary to consider variations in margin of transmission power in unicast communication, estimate the margin of transmission power in unicast communication in time symbols to which boosting of transmission power in MBS communication is to be applied, and perform scheduling for MBS communication on the time symbols to which boosting of transmission power in MBS communication is to be applied. In other words, it is necessary to allocate, to boosting of transmission power in MBS communication, a value obtained by subtracting the amount of variations from the margin of transmission power in unicast communication at the time of MBS scheduling. Thus, it is very difficult to control boosting of transmission power for MBS channels by considering variations in transmission power in unicast communication.

The second challenge is that the amount by which a plurality of base stations boost transmission power in MBS communication needs to be the same. A pilot channel signal is a reference signal indicating a known reference phase. To demodulate a macro diversity signal using a pilot channel signal if transmission power of the pilot channel signal is not boosted, it is necessary that the power ratio between the pilot channel signal and the macro diversity signal be maintained constant at all base stations that transmit the same macro diversity signal. However, a margin of transmission power in unicast communication actually varies from one base station to another due to variations in cell size. Since a large cell site of a base station means high transmission power in unicast communication, a margin of transmission power in unicast communication is small. Therefore, a transmission power boost value in MBS communication at each base station needs to be determined in accordance with a smallest transmission power margin among base stations present in a multicast/broadcast service area.

Specifically, as illustrated in FIG. 2, in the case of multicast/broadcast service area #1 including base stations #1 to #6, base station #5 has the smallest transmission power margin among base stations #1 to #6 present in multicast/broadcast service area #1. Therefore, a transmission power boost value in MBS communication at each of base stations #1 to #6 is determined in accordance with the transmission power margin at base station #5. In the case of multicast/broadcast service area #2 including base stations #1 and #2, base station #2 has a smaller transmission power margin between base stations #1 and #2 present in multicast/broadcast service area #2. Therefore, a transmission power boost value in MBS communication at each of base stations #1 and #2 is determined in accordance with the transmission power margin at base station #2.

As described above, there are two challenges in controlling boosting of transmission power for MBS channels. That is, it may not be possible to boost transmission power in MBS communication simply by allocating a margin of transmission power in unicast communication to MBS communication.

Another challenge is that even when transmission power in MBS communication may be boosted, there may be an increase in the effect of interference power on a cell adjacent to a multicast/broadcast service area, the interference power occurring at a boundary of the multi cast/broadcast service area. Since an MBSFN environment is assumed within a multicast/broadcast service area, boosting transmission power in MBS communication does not cause interference between base stations. However, for base stations and mobile stations MS that perform unicast communication using the same frequency-time resource outside the boundary of the multicast/broadcast service area, an increase in transmission power from the multicast/broadcast service area causes interference between base stations. Here, in unicast communication, each mobile station MS measures the reception environment and notifies a base station of the measured reception environment. In accordance with the reception environment of each mobile station MS, the base station determines a modulation method and a coding rate, and performs scheduling of physical resources (adaptive modulation). Therefore, if mobile station MS measures a reception environment while a cell adjacent to the multicast/broadcast service area is performing unicast communication, interference at the boundary of the multicast/broadcast service area may have some impact on the measured reception environment. As a result, scheduling is performed on the basis of the reception environment affected by the interference at the boundary of the multicast/broadcast service area. Therefore, if transmission power in MBS communication is boosted in the multicast/broadcast service area, it is difficult to ensure necessary reception quality of unicast communication in a cell adjacent to the multicast/broadcast service area.

### SUMMARY OF THE INVENTION

The present invention has been made in view of the circumstances described above. An object of the present invention is to provide a communication processing system, an OFDM signal transmitting method, an OFDM transmitter, an OFDM receiver, and a control station capable of controlling boosting of transmission power for MBS channels.

Another object of the present invention is to provide a communication processing system, an OFDM signal transmitting method, an OFDM transmitter, an OFDM receiver, and a control station capable of avoiding interference on a base station for unicast communication caused by boosting of transmission power for MBS channels, the base station being adjacent to the boundary of a multicast/broadcast service area.

In order to attain the above-mentioned object, according to an aspect of the present invention, there is provided a communication processing system comprising: an OFDM transmitter; and one or plural control stations configured to provide the same service area including a plurality of OFDM transmitters which are close or substantially the same in cell size, wherein the one or plural control stations transmit first, data, second data, and time symbol information to all the OFDM transmitters included in the same service area, receive transmission power margins from the respective OFDM transmitters included in the same service area, determine a transmission power boost value on the basis of the received transmission power margins, and transmit the determined transmission power boost value to all the OFDM transmitters included in the same service area; and each of the OFDM transmitters included in the same service area receives the first data, the second data, and the time symbol information from the one or plural control stations, calculates a transmission power margin in a time symbol based on the time symbol information from the control, station, transmits the calculated transmission power margin to the control station, receives a transmission power boost value from the control station, multiplies a data channel signal corresponding to the first data by the received transmission power boost value, generates, in the time symbol based on the time symbol information, an OFDM signal in which a macro diversity signal corresponding to one first data and a non-macro diversity signal corresponding to the second data are frequency-division-multiplexed, and outputs the generated OFDM signal to an OFDM receiver.

In order to attain the above-mentioned object, according to another aspect of the present invention, there is provided an OFDM signal transmitting method of an OFDM transmitter-included in a service area, the OFDM signal transmitting method comprising: a data channel signal generating step of generating a data channel signal including at least one of a first data channel signal and a second data channel signal by modulating a bit string obtained by channel coding; a pilot channel signal generating step of generating a pilot channel signal; an assigning step of assigning the pilot channel signal generated in the pilot channel signal generating step and the data channel signal generated in the data channel signal generating step to a pilot subcarrier and a data subcarrier, respectively; a scrambling step of multiplying the pilot channel signal and the first data channel signal assigned to the pilot subcarrier and the data subcarrier, respectively, by a predetermined scrambling code orthogonal or near-orthogonal among service areas and unique to each service area, and multiplying the second data channel signal assigned to the data subcarrier by a predetermined scrambling code orthogonal or near-orthogonal among OFDM transmitters and unique to each OFDM transmitter; a transmission power boost step of multiplying, if the first data channel signal is included in the data channel signal, the first data channel signal multiplied by the scrambling code in the scrambling step by a transmission power boost value notified in advance from one or more control stations which control OFDM transmitters included in the same service area to all the OFDM transmitters included in the same service area; an OFDM signal generating step of generating, in a time symbol based on time symbol information from one of the one or more control stations, an OFDM signal by OFDM-modulating the pilot channel signal and the second data channel signal multiplied by the scrambling codes in the scrambling step and the first data channel signal multiplied by the transmission power boost value in the transmission power boost step, the OFDM signal being a signal in which a macro diversity signal corresponding to the first data channel signal and a non-macro diversity signal corresponding to the second data channel signal are frequency-division-multiplexed; and a transmitting step of transmitting the OFDM signal generated in the OFDM signal generating step to an OFDM receiver via an antenna.

In order to attain the above-mentioned object, according to another aspect of the present invention, there is provided an OFDM transmitter included in a service area, the OFDM transmitter comprising: a data channel signal generating unit configured to generate a data channel signal including at least one of a first data channel signal and a second data channel signal by modulating a bit string obtained by channel coding; a pilot channel signal generating unit configured to generate a pilot channel signal; an assigning unit configured to assign the pilot channel signal generated by the pilot channel signal generating unit and the data channel signal generated by the data channel signal generating unit to a pilot subcarrier and a data subcarrier, respectively; a scrambling unit configured to multiply the pilot channel signal and the first data channel signal assigned to the pilot subcarrier and the data subcarrier, respectively, by a predetermined scrambling code orthogonal or near-orthogonal among service areas and unique to each service area, and multiply the second data channel signal assigned to the data subcarrier by a predetermined scrambling code orthogonal or near-orthogonal among OFDM transmitters and unique to each OFDM transmitter; a transmission power boost unit configured to multiply, if the first data channel signal is included in the data channel signal, the first data channel signal multiplied by the scrambling code by the scrambling unit by a transmission power boost value notified in advance from one or more control stations which control OFDM transmitters included in the same service area to all the OFDM transmitters included in the same service area; an OFDM signal generating unit configured to generate, in a time symbol based on time symbol information from one of the one or more control stations, an OFDM signal by OFDM-modulating one pilot channel signal and the second data channel, signal multiplied by the scrambling codes by the scrambling unit and the first data channel signal multiplied by the transmission power boost value by the transmission power boost unit, the OFDM signal being a signal in which a macro diversity signal corresponding to the first data channel signal and a non-macro diversity signal corresponding to the second data channel signal are frequency-division-multiplexed; and a transmitting unit configured to transmit the OFDM signal generated by the OFDM signal generating unit to an OFDM receiver via an antenna.

In order to attain the above-mentioned object, according to another aspect of the present invention, there is provided an OFDM receiver comprising: a receiving unit configured to receive an OFDM signal transmitted from an OFDM transmitter included in a service area; an OFDM demodulation unit configured to OFDM-demodulate the OFDM signal received by the receiving unit into signals for respective subcarriers; a separating unit configured to separate, from the signals obtained by the OFDM demodulation unit, a pilot channel signal and a data channel signal assigned to the respective subcarriers; a descrambling unit configured to descramble, by using a scrambling code unique to the service area, the pilot channel signal separated by the separating unit and a first data channel signal included in the data channel signal separated by the separating unit, and descramble, by using a scrambling code unique to the OFDM transmitter, a second data channel signal included in the data channel signal separated by the separating unit; a transmission power deboost unit configured to multiply the first data channel signal descrambled by the descrambling unit by a reciprocal of a transmission power boost value notified in advance to all OFDM transmitters included in the same service area; a channel estimation unit configured to perform channel estimation on the data channel signal separated by the separating unit, on the basis of the pilot channel signal separated by the separating unit; an equalizing unit configured to equalize, by using a channel estimate obtained by the channel estimation unit, the second data channel signal descrambled by the descrambling unit and one first data channel signal multiplied by the reciprocal of the transmission power boost value by the transmission power deboost unit; and a data demodulating unit configured to demodulate the first data channel signal and the second data channel signal equalized by the equalizing unit.

In order to attain the above-mentioned object, according to another aspect of the present invention, there is provided a control station providing a service area including a plurality of OFDM transmitters which are close or substantially the same in cell size, the control station comprising: a data transmitting unit configured to transmit first data, second data, and time symbol information to all the OFDM transmitters included in one same service area; a receiving unit configured to receive transmission power margins from the respective OFDM transmitters included in the same service area; a determining unit configured to determine a transmission power boost value on the basis of the transmission power margins received by the receiving unit; and a transmission power boost value transmitting unit configured to transmit the transmission power boost value determined by the determining unit to all the OFDM transmitters included in the same service area.

According to an embodiment of the present invention, it is possible to control boosting of transmission power for MBS channels.

### BRIEF DESCRIPTION OF THE DRAWINGS

FIG. 1A and FIG. 1B illustrate a known method in which a non-macro diversity signal and a macro diversity signal are frequency-division-multiplexed or space-division-multiplexed.

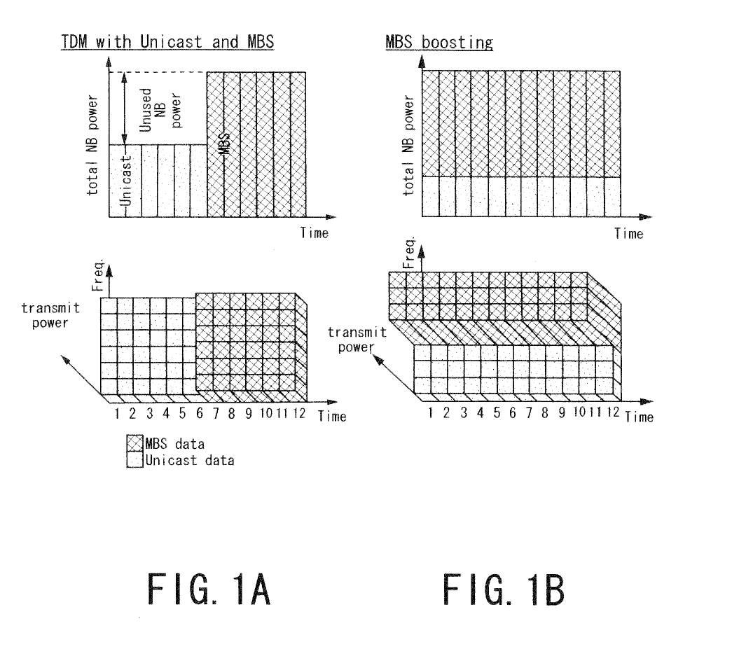

FIG. 2 illustrates a known method for determining a transmission power boost value in MBS communication at each base station.

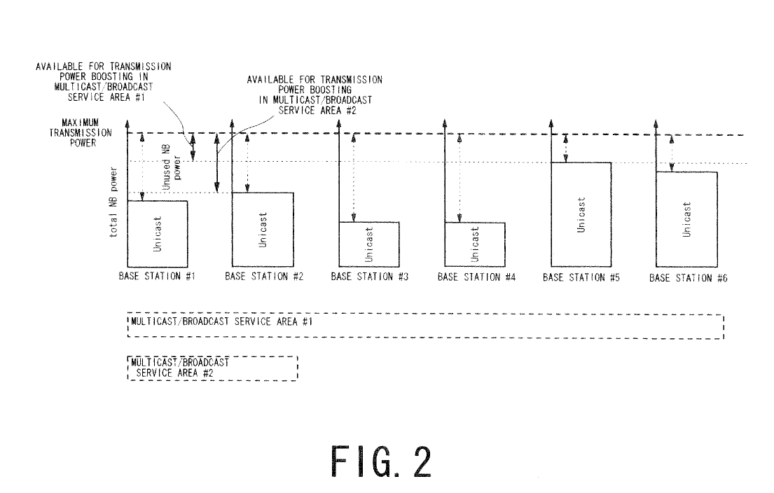

FIG. 3 illustrates a schematic configuration of a radio communication system according to an embodiment of the present invention.

FIG. 4 illustrates an example of a configuration of a network system including an MBS database, MBS control stations serving as OFDM transmitter control stations, and base stations serving as OFDM transmitters.

FIG. 5 illustrates a process flow between an MBS control station serving as an OFDM transmitter control station and base station #k serving as an OFDM transmitter and controlled by one MBS control station.

FIG. 6 illustrates how physical resources are allocated to unicast communication, MBS communication for MBS 1, and MBS communication for MBS 4.

FIG. 7 is a block diagram illustrating an internal configuration of an OFDM transmitter illustrated in FIG. 3.

FIG. 8 is a block diagram illustrating an internal configuration of an OFDM receiver illustrated in FIG. 3.

FIG. 9 illustrates degradation in reception quality caused by boosting of transmission power in MBS communication in a cell adjacent to a multicast/broadcast service area.

FIG. 10 illustrates how scheduling is performed at base stations #m and #n serving as OFDM transmitters.

FIG. 11 illustrates a process flow between an MBS control station serving as an OFDM transmitter control station and base station #n serving as an OFDM transmitter and controlled by the MBS control station.

### DESCRIPTION OF THE PREFERRED EMBODIMENTS

Hereinafter, embodiments of the present invention will be described with reference to the drawings.

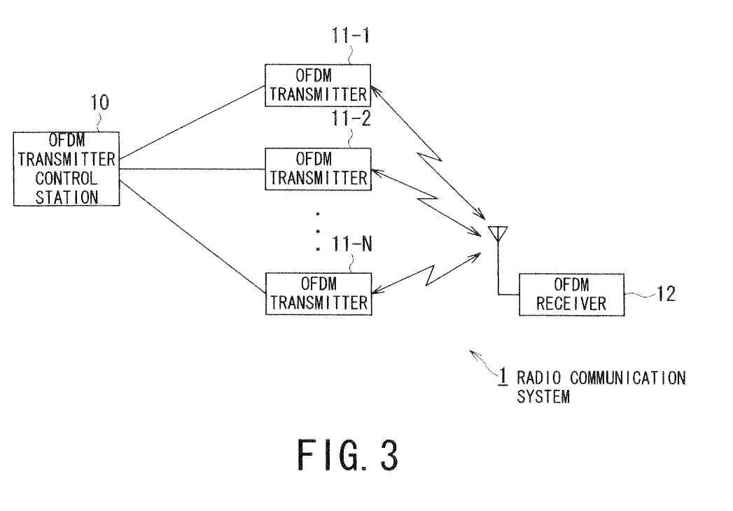

FIG. 3 illustrated a schematic configuration of a radio communication system 1 according to an embodiment of the present invention. As illustrated in FIG. 3, the radio communication system 1 includes an OFDM transmitter control station 10, a plurality (N) of OFDM transmitters 11-1, 11-2, . . . , and 11-N, am an OFDM receiver 12 capable of receiving OFDM signals transmitted from the OFDM transmitters 11-1 to 11-N through different channels (propagation paths). The OFDM transmitters 11-1 to 11-N each transmit an OFDM signal to the OFDM receiver 12. It is not always necessary that all the OFDM transmitters 11-1 to 11-N be located in different places, and some of the OFDM transmitters 11-1 to 11-N may be located in the same place. For example, two of the OFDM transmitters 11-1 to 11-N may be included in one radio communication apparatus. In such a case, since a component, such as a subcarrier assignment unit (described below), of the OFDM transmitters 11-1 to 11-N is common to all one OFDM transmitters 11-1 to 11-N, such a component may be shared by some of the OFDM transmitters 11-1 to 11-N.

If one or more of the OFDM transmitters 11-1 to 11-N operate together for power control or the like, the OFDM transmitter control station 10 controls the operation of each of the one or more of the OFDM transmitters 11-1 to 11-N.

The OFDM transmitters 11-1 to 11-N illustrated in FIG. 3 each serve as a “base station” in a cellular system (cellular phone system). The OFDM receiver 12 illustrated in FIG. 3 serves as “mobile station MS”. Hereinafter, if it is not necessary to make distinctions among the OFDM transmitters 11-1 to 11-N, they will be collectively referred to as OFDM transmitters 11. To specifically discuss a multicast/broadcast service in the embodiments of the present invention, the OFDM transmitter control station 10 will be referred to as an “MBS control station”, unless otherwise stated.

An MBS control station serving as the OFDM transmitter control station 10 is capable of providing not only one multicast/broadcast service area (i.e., a group of base stations supporting the same MBS), but a plurality of different multicast/broadcast service areas.

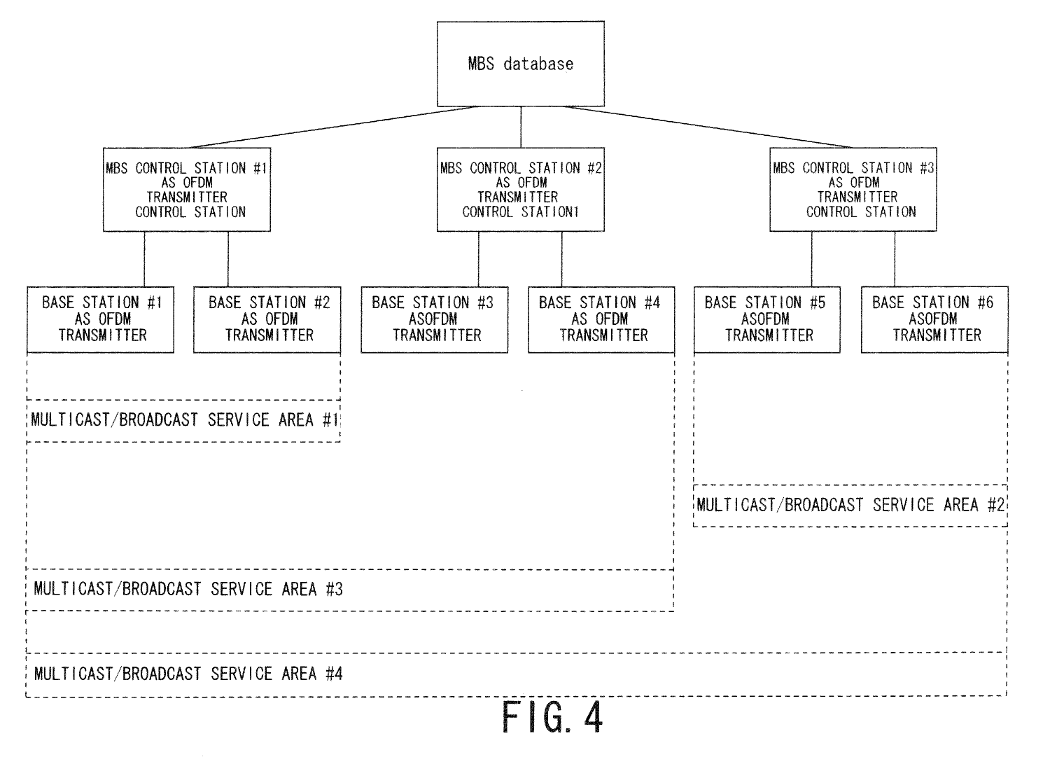

FIG. 4 illustrates an example of a configuration of a network system inducing an MBS database, MBS control stations each serving as the OFDM transmitter control station 10, and base stations serving as the OFDM transmitters 11.

In the case of FIG. 4, multicast/broadcast service area #1 covers cell areas of base stations #1 and #2 serving as the OFDM transmitters 11. Likewise, multicast/broadcast service area #2 covers cell areas of base stations #5 and #6 serving as the OFDM transmitters 11, and multicast/broadcast service area #3 covers cell areas of base stations #1 to #4 serving as the OFDM transmitters 11. Multicast/broadcast service area #4 covers cell areas of all base stations #1 to #6 serving as the OFDM transmitters 11. Thus, base station #1 controlled by MBS control station #1 is covered by multicast/broadcast service areas #1, #3, and #4. In other words, base station #1 is included in multicast/broadcast service areas #1, #3, and #4. Therefore, base station #1 can randomly or selectively receive MBSs for these three multicast/broadcast service areas #1, #3, and #4. Here, MBSs performed for mobile stations MS (each serving as the OFDM receiver 12) present in multicast/broadcast service areas #1, #2, #3, and #4 are referred to as “MBS 1”, “MBS 2”, “MBS 3”, and “MBS 4”, respectively.

In FIG. 4, to simplify explanation, the number of base stations controlled by one MBS control station is two. However, this number is not limited to two. That is, one MBS control station may control three or more base stations.

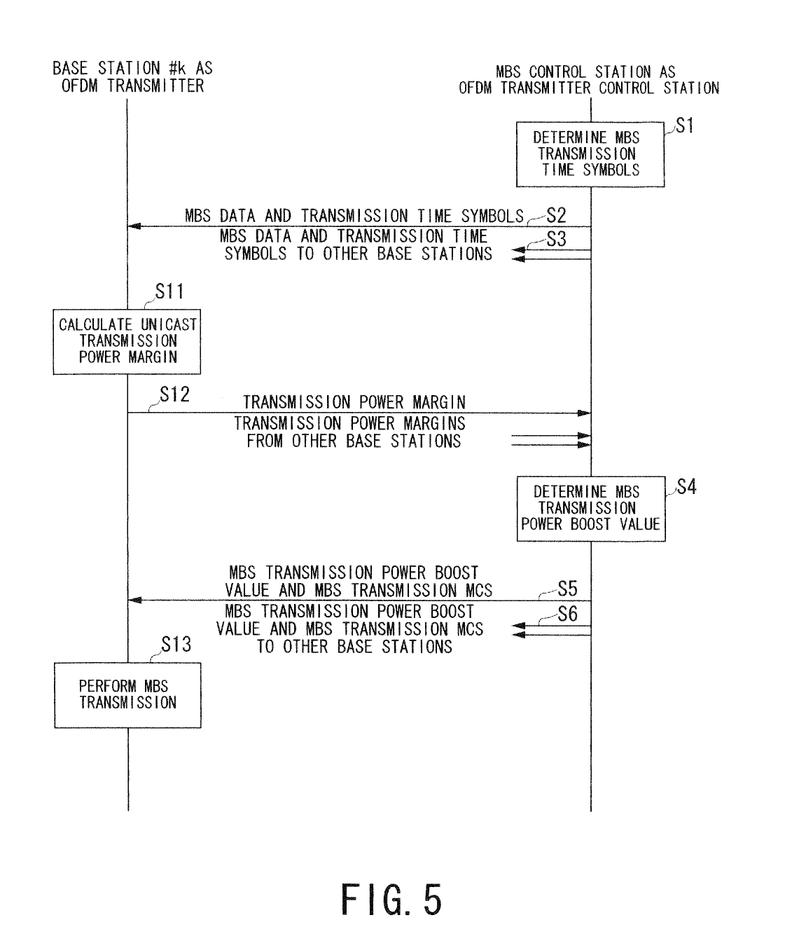

FIG. 5 illustrates a process flow between an MBS control station serving as the OFDM transmitter control station 10 and base station #k serving as the OFDM transmitter 11 and controlled by the MBS control station.

As illustrated in FIG. 5, in step S1, upon completion of preparation of MBS transmission data, the MBS control station schedules and determines MBS transmission time symbols. Here, an MBS having a multicast/broadcast service area closed within one MBS control station is given priority to be frequency-division-multiplexed with unicast communication. Specifically, in the case of FIG. 4, MBS 1 and MBS 2 each have a multicast/broadcast service area closed within one MBS control station. On the other hand, MBS 3 and MBS 4 each, have a multicast/broadcast service area which is not closed within one MBS control station and extends over a plurality of MBS control stations. Therefore, MBS 1 and MBS 2 are given higher priority to be frequency-division-multiplexed with unicast communication than MBS 3 and MBS 4.

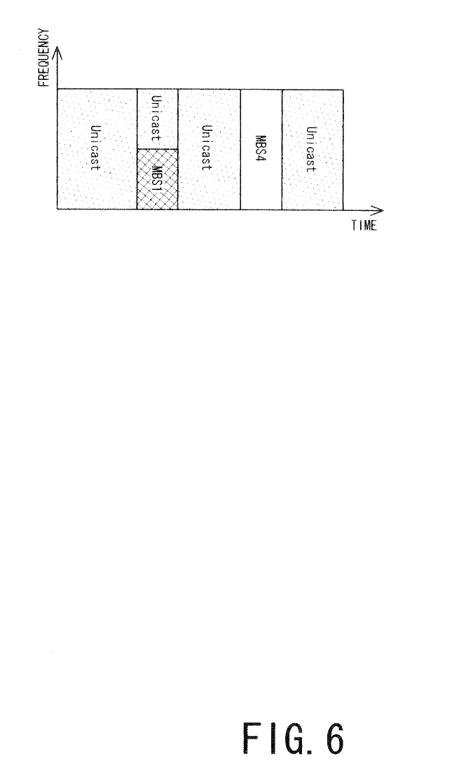

FIG. 6 illustrates how physical resources are allocated to unicast communication, MBS communication for MBS 1, and MBS communication for MBS 4. As described with reference to FIG. 6, MBS 1 has a multicast/broadcast service area closed within one MBS control station. That is, multicast/broadcast service area #1 includes only base stations (base stations #1 and #2) controlled by MBS control station #1. On the other hand, MBS 4 has a multicast/broadcast service area extending over a plurality of MBS control stations. That is, multicast/broadcast service area #4 extends over a plurality of MBS control stations (MBS control stations #1 to #3). Here, as illustrated in FIG. 6, MBS communication for MBS 1 is frequency-division-multiplexed with unicast communication, and MBS communication for MBS 4 is time-division-multiplexed with unicast communication.

In the example described above, since it is possible to assume that an MBS having a multicast/broadcast service area including only base stations controlled by one MBS control station is an “MBS for which it is easy to control boosting of MBS transmission power”, this MBS is given priority to be frequency-division-multiplexed with unicast communication. However, “MBS for which it is easy to control boosting of MBS transmission power” in this embodiment of the present invention includes those other than the MBS having a multicast/broadcast service area including only base stations controlled by one MBS control start on. For example, an MBS having a multicast/broadcast service area including only base stations controlled by a very small number of MBS control stations is also included in “MBS for which it is easy to control boosting of MBS transmission power”.

Generally, in the case of an MBS providing services in a large area, a multicast/broadcast service area corresponding to this MBS includes many base stations (OFDM transmitters 11). As the number of base stations increases, it becomes difficult to determine the smallest value among transmission power margins at all base stations in real time, and, moreover, difficult to expect a sufficient margin. Therefore, a determination as to whether the MBS is an “MBS for which it is easy to control boosting of MBS transmission power” may be made on the basis of whether the MBS has a multicast/broadcast service area including only a small number of base stations that are close or substantially the same in cell size. This is because of the following reasons.

That is, in the case of an MBS having a multicast/broadcast service area including only base stations belonging to one or a very small number of MBS control stations, since the multicast/broadcast service area includes a small number of base stations that are close in distance, it is easy to determine the smallest value among transmission power margins at all the base stations in real time. Additionally, since coverage areas of such base stations are generally substantially the same, their corresponding margins of transmission power may also be substantially the same. It is thus possible to use the margin of transmission power for boosting MBS transmission power without waste. Therefore, it is possible to use an optimum transmission power boost value when an MBS has a multicast/broadcast service area including only a small number of base stations that are close or substantially the same in cell size.

In other words, this means that the transmission power boost value basically differs from one MBS to another having a multicast/broadcast service area.

As described above, in this embodiment of the present invention, a determination as to whether the MBS is an “MBS for which it is easy to control boosting of MBS transmission power” is made on the basis of whether the MBS has a multicast/broadcast service area including only a small number of base stations that are close or substantially the same in cell size. Then, if the MBS is an “MBS for which it is easy to control boosting of MBS transmission power”, the MBS is given priority to be frequency-division-multiplexed with unicast communication. On the other hand, if the MBS is not an “MBS for which if is easy to control boosting of MBS transmission power”, the MBS is time-division-multiplexed with unicast communication.

Referring back to FIG. 5, in step S2, the MBS control station notifies base station #k of the MBS transmission time symbols. At the same time, the MBS control station transmits the MBS data to base station #k. In step S3, the MBS control station notifies the other base stations also controlled by the MBS control station of the MBS transmission time symbols, and transmits the MBS data to the other base stations.

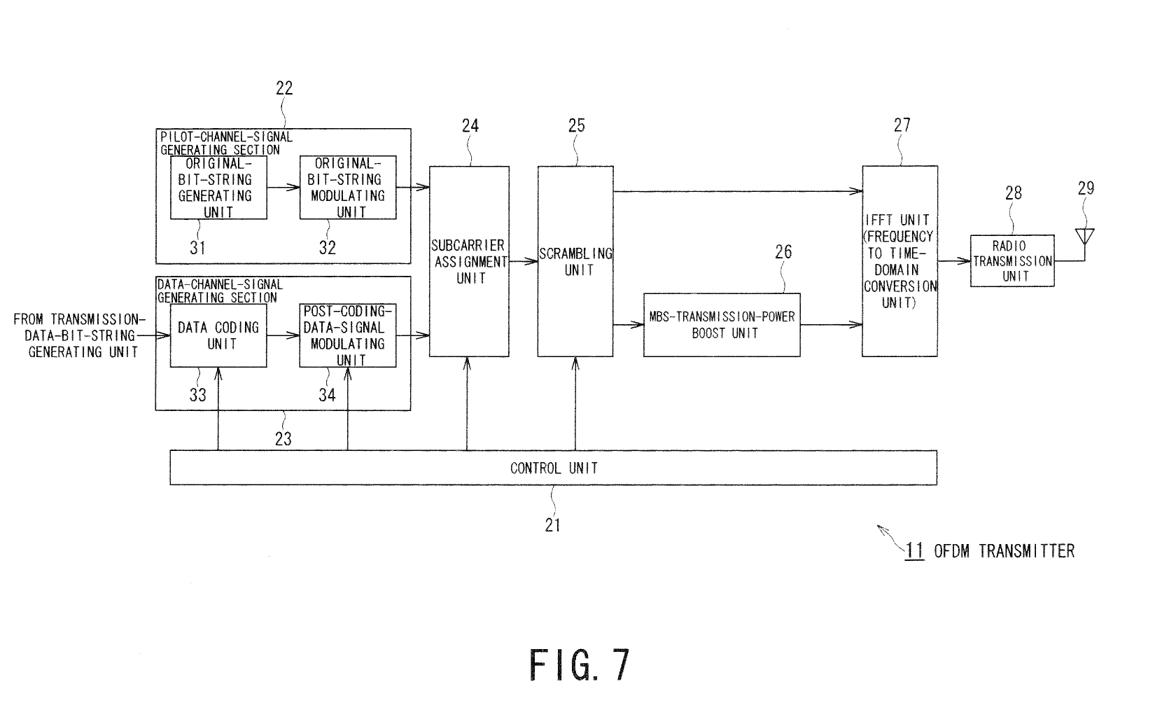

In step S11, in consideration of traffic conditions, a control unit (i.e., control unit 21 (described below) illustrated in FIG. 7) of base station #k calculates a transmission power margin in the received transmission time symbols by the following equation:

Transmission power margin=Maximum transmission power−{(Transmission power in unicast communication at the time of calculation of transmission power margin+Variations in unicast transmission power)×Ratio of unicast frequency resources in MBS transmission}

In step S12, base station #k notifies the MBS control station of the calculated transmission power margin. At the same time, the other base stations each notify the MBS control station of the calculated transmission power margin. In step S4, the MBS control station determines the smallest value among the transmission power margins from all the base stations as an MBS transmission power boost value. An “MBS transmission power boost value” is a coefficient (or factor) relative to transmission power of an OFDM signal corresponding to a unicast data channel signal. In step S5, the MBS control station transmits the determined MBS transmission power boost value to base station #k. In step S6, the MBS control station transmits the determined MBS transmission power boost value also to the other base stations. Since a modulation method and a coding rate (MCS) in MBS transmission are determined on the basis of this MBS transmission power boost value, they are transmitted to each base station at this point.

In step S13, base station #k uses the MBS transmission MCS transmitted from the MBS control station to code and modulate the MBS data. Base station #k frequency-division-multiplexes the modulated macro diversity signal and a non-macro diversity signal, and MBS-transmits them to mobile station MS serving as the OFDM receiver 12 by using predetermined physical resources.

FIG. 7 illustrates an internal configuration of an OFDM transmitter 11 illustrated in FIG. 3. As illustrated in FIG. 7, the OFDM transmitter 11 includes a control unit 21, a pilot-channel-signal generating section 22, a data-channel-signal generating section 23, a subcarrier assignment unit 24, a scrambling unit 25, an MBS-transmission-power boost unit 26, an IFFT unit (inverse fast Fourier transform unit or frequency to time-domain conversion unit) 27, a radio transmission unit 28, and an antenna 29.

The control unit 21 performs overall control of the OFDM transmitter 11, and controls the pilot-channel-signal generating section 22, the data-channel-signal generating section 23, the subcarrier assignment unit 24, the scrambling unit 25, and the IFFT unit 27.

The pilot-channel-signal generating section 22 includes an original-bit-string generating unit 31 and an original-bit-string modulating unit 32. The original-bit-string generating unit 31 generates an original bit string of which pilot channel signals are to be formed, and outputs the generated original bit string to the original-bit-string modulating unit 32. The original-bit-string modulating unit 32 applies digital modulation, such as orthogonal phase shift keying (QPSK), to the original bit string from the original-bit-string generating unit 32 so as to generate pilot channel signals.

There are two possible methods for frequency-division-multiplexing a macro diversity signal (MBS signal) and a non-macro diversity signal (unicast signal). In one method, different pilot channel signals are used in frequency-division-multiplexing a macro diversity signal and a non-macro diversity signal. In another method, the same pilot channel signal at the transmitting end is used in frequency-division-multiplexing a macro diversity signal and a non-macro diversity signal, while a channel response of a non-macro diversity signal and a channel response of a macro diversity signal are determined with a devised channel estimation technique at the receiving end. Although the present embodiment will be described on the basis of the latter method, the former method may be used.

The data-channel-signal generating section 23 includes a data coding unit 33 and a post-coding-data-signal modulating unit 34. At a channel coding rate specified by the control unit 21, the data coding unit 33 applies channel coding to a transmission data bit string (down-transmission data bit string) generated by a transmission-data-bit-string generating unit. Then, the data coding unit 33 outputs the resulting post-coding data signal to the post-coding-data-signal modulating unit 34. By a modulation method specified by the control unit 21, the post-coding-data-signal modulating unit 34 applies digital modulation, such as orthogonal phase shift keying (QPSK), to the post-coding data signal so as to generate transmission data channel signals. A different coding rate and a different modulation method may be used depending on whether the transmission data channel signal to be generated by the data-channel-signal generating section 23 is a non-macro diversity signal or a macro diversity signal.

The pilot channel signals generated by the pilot-channel-signal generating section 22 and the data channel signals (MBS data channel signals/unicast data channel signals) generated by the data-channel-signal generating section 23 can both be represented by complex numbers. The pilot channel signals are used for channel estimation (estimation of channel response) in the OFDM receiver 12. The pilot channel signals may also be used for timing synchronization or frequency synchronization in the OFDM receiver 12. In the following embodiment, the pilot channel signals are used for channel estimation in the OFDM receiver 12.

An MBS data channel signal is defined as a “first data channel signal”, and a unicast data channel signal, is defined as a “second data channel signal”.

The subcarrier assignment unit 24 assigns the pilot channel signals from the pilot-channel-signal generating section 22 and time data channel signals (MBS data channel signals/unicast data channel signals) from the data-channel-signal generating section 23 to their corresponding subcarriers, that, is, to pilot subcarriers and data subcarriers (MBS data channel subcarriers/unicast data channel subcarriers), respectively. Here, the expression “assigning a signal to a subcarrier” refers to an operation in which, to a signal represented by a complex number, a subcarrier index indicating the position of the corresponding subcarrier on the time and frequency axes is added.

Here, the MBS control station serving as the OFDM transmitter control station 10 notifies, in advance, a base station serving as the OFDM transmitter 11 of physical resources (frequency-time resources) allocated to the MBS data. In accordance with the notification from the MBS control station, the case station allocates, to the MBS data channel signals, the frequency-time resources common to all base stations present in the same multicast/broadcast service area. Thus, macro diversity reception is applied to macro diversity signals.

Specifically, as illustrated in FIG. 6, MBS communication for MBS 1 is frequency-division-multiplexed with unicast communication. Frequency-time resources are allocated to the MBS communication in advance by the MBS control station serving as the OFDM transmitter control station 10.

The scrambling unit 25 multiplies the pilot channel signals and the data channel signals (MBS data channel signals) by a predetermined scrambling code unique to the multicast/broadcast service area and orthogonal or near-orthogonal among multicast/broadcast service areas. A purpose of scrambling is to randomize modulated data symbols and pilot symbols between OFDM transmitters 11 belonging to adjacent multicast/broadcast service areas. The scrambling code unique to the multicast/broadcast service area is common to the OFDM transmitters 11 belonging to the multicast/broadcast service area.

Additionally, the scrambling unit 25 multiplies the data channel signals (unicast data channel signals) assigned to the respective data subcarriers by a predetermined scrambling code unique to the OFDM transmitter 11 and orthogonal or near-orthogonal among the OFDM transmitters 11.

The scrambling unit 25 outputs the scrambled pilot channel signals and unicast data channel signals directly to the IFFT unit 27 serving as an OFDM modulator. At the same time, the scrambling unit 25 outputs the scrambled MBS data channel signals to the MBS-transmission-power boost unit 26.

The MBS-transmission-power boost unit 26 multiplies each MBS data channel signal by an MBS transmission power boost value received in advance from the MBS control station serving as the OFDM transmitter control station 10, and outputs the resulting signals to the IFFT unit 27.

The IFFT unit 27 OFDM-modulates the signals from the scrambling unit 25 to generate an OFDM signal which is a sequence of a plurality of OFDM symbols. That is, the IFFT unit 27 generates an OFDM signal by converting signals in the frequency domain into those in the time domain. Then, a guard interval (GI) adding unit (not shown) adds a GI to the OFDM signal generated by the IFFT unit 27. The resulting OFDM signal is converted into a radio signal (RF signal) by the radio transmission unit 28 including a digital-to-analog converter, an up-converter, and a power amplifier, and is transmitted from the antenna 29.

In particular, for execution of MBS transmission processing at a base station serving as the OFDM transmitter 11, the IFFT unit 27 generates an OFDM signal in which a macro diversity signal and a non-macro diversity signal are frequency-division-multiplexed. Then, the radio transmission unit 28 transmits the OFDM signal via the antenna 29. Thus, as illustrated in FIG. 6, MBS communication for MBS 1 is frequency-division-multiplexed with unicast communication. On the other hand, MBS communication for MBS 4 is time-division-multiplexed with unicast communication. This MBS transmission processing starts to be in time for the order of MBS transmission time symbols, after a modulation method and a coding rate for MBS transmission and an MBS transmission power boost value are received from the MBS control station by the base station.

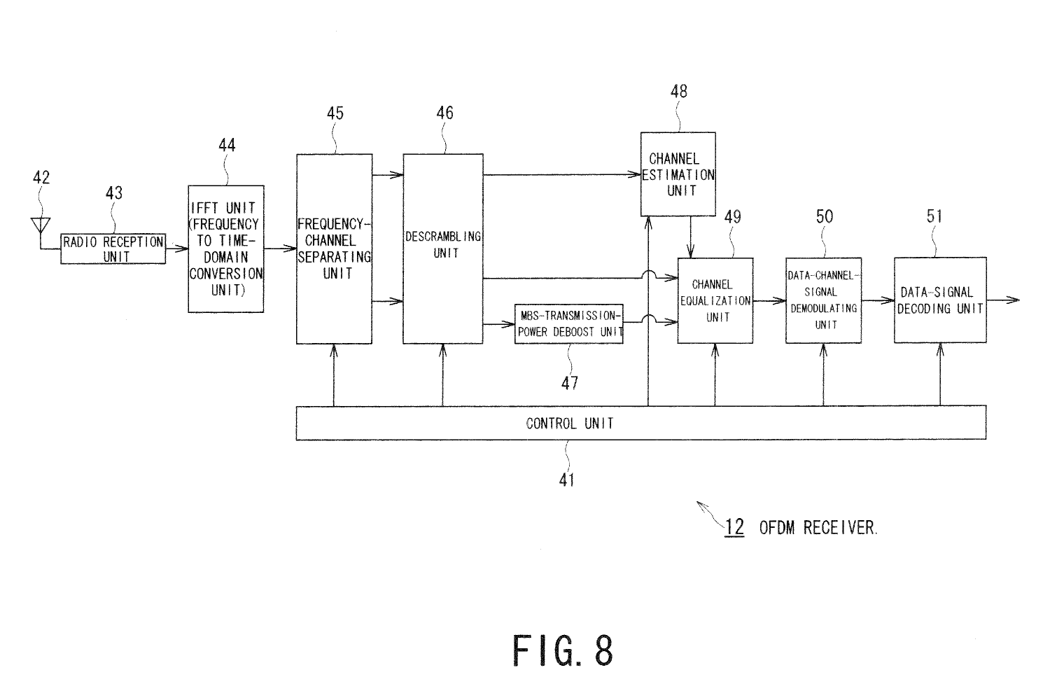

FIG. 8 illustrates an internal configuration of the OFDM receiver 12 illustrated in FIG. 3. FIG. 8 illustrates a configuration related to macro diversity reception and non-macro diversity reception of the OFDM receiver 12. As illustrated in FIG. 8, the OFDM receiver 12 includes a control unit 41, an antenna 42, a radio reception unit 42, an FFT unit (fast Fourier transform unit or time to frequency-domain conversion unit) 44, a frequency-channel separating unit 45, a descrambling unit 46, an MBS-transmission-power deboost unit 47, a channel estimation unit 48, a channel equalization unit 49, a data-channel-signal demodulating unit 50, and a data-signal decoding unit 51.

The control unit 41 performs overall control of the OFDM receiver 12, and controls the frequency-channel separating unit 45, the descrambling unit 46, the channel estimation unit 48, the channel equalization unit 49, the data-channel-signal demodulating unit 50, and the data-signal decoding unit 51.

A radio signal received by the antenna 42 is converted into a baseband digital, signal by the radio reception unit 43 including a low-noise amplifier, a down-converter, and an analog-to-digital converter. After a guard interval is removed from the baseband digital signal by a GI removing unit, the baseband digital signal in the time domain is divided by the FFT unit 44 into signals in the frequency domain, that is, into signals for respective subcarriers. The FFT unit 44 outputs the signals for the respective subcarriers to the frequency-channel separating unit 45. The frequency-channel separating unit 45 separates pilot channel signals and data channel signals (unicast data channel signals and MBS data channel signals) that are assigned to their corresponding subcarriers. The frequency-channel separating unit 45 outputs the separated signals (pilot channel signals and data channel signals) to the descrambling unit 46. The descrambling unit 46 descrambles each of the received signals with a scrambling code sequence used for multiplication by the OFDM transmitter 11, and outputs the descrambled pilot signals to the channel estimation unit 48, outputs the descrambled unicast data channel signals to the channel equalization unit 49, and outputs the descrambled MBS data channel signals to the MBS-transmission-power deboost unit 47. The scrambling code sequence used for multiplication by the OFDM transmitter 11 is known to the OFDM receiver 12.

The MBS-transmission power deboost unit 47 inputs, to the channel equalization unit 49, signals obtained by multiplying the MBS data channel signals by the reciprocal of an MBS transmission power boost value. Here, the OFDM receiver 12 is notified, in advance, of one MBS transmission power boost value and information about a modulation method and a coding rate.

The channel estimation unit 48 uses the descrambled pilot channel signals to estimate respective channel responses of the unicast data channel signals and the MBS data channel signals. The channel estimation unit 48 outputs channel estimates indicating the respective channel responses of the unicast data channel signals and the MBS data channel signals to the channel equalization unit 49. The channel equalization unit 49 uses the channel estimates from the channel estimation unit 48 to perform channel equalization on each of the data channel signals. After the channel equalization, the data channel signals are demodulated by the data-channel-signal demodulating unit 50. Thus, a bit string of which a data signal is formed is reproduced by the data-signal decoding unit 51.

A communication processing system according to an embodiment of the present invention includes the OFDM transmitter 11 and one or more OFDM transmitter control stations 10 configured to provide the same service area including the plurality of OFDM transmitters 11 that are close or substantially the same in cell size. The one or more OFDM transmitter control stations 10 transmit first data, second data, and time symbol information to all the OFDM transmitters 11 included in the same service area, receive transmission power margins from the respective OFDM transmitters 11 included in the same service area, determine a transmission power boost value on the basis of the received transmission power margins, and transmit the determined transmission power boost value to all the OFDM transmitters 11 included in the same service area. Each of the OFDM transmitters 11 included in the same service area receives the first data (MBS data), the second data (unicast data), and the time symbol information from one of the one or more OFDM transmitter control stations 10; calculates a transmission power margin in a time symbol based on the time symbol information from the OFDM transmitter control station 10; transmits the calculated transmission power margin to the OFDM transmitter control station 10; receives a transmission power boost value from the OFDM transmitter control station 10; multiplies a data channel signal corresponding to the first data by the received transmission power boost value; generates, in the time symbol based on the time symbol information, an OFDM signal in which a macro diversity signal corresponding to the first data and a non-macro diversity signal corresponding to the second data are frequency-division-multiplexed; and outputs the generated OFDM signal to the OFDM receiver 12.

Thus, it is possible to use an optimum transmission power boost value in a multicast/broadcast service area including the plurality of OFDM transmitters 11 that are close or substantially the same in cell size. Therefore, it is possible to control the boosting of transmission power for MBS channels, allocate an unused transmission power margin in unicast communication to MBS communication, and thus improve the use efficiency of frequencies in MBS communication. This makes it possible to make maximum use of limited physical resources.

If a base station belonging to a multicast/broadcast service area boosts transmission power in MBS communication, it is difficult to ensure necessary reception quality of unicast communication in a cell adjacent to the multicast/broadcast service area.

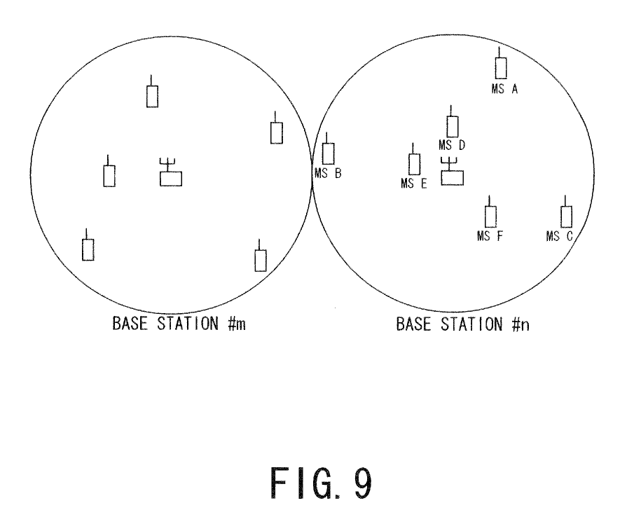

Referring to FIG. 9, base station #m is one of base stations included in one multicast/broadcast service area. Base station #m boosts transmission power in MBS communication during MBS transmission. On the other hand, base station #n adjacent to base station #m does not belong to any multicast/broadcast service area. Base station #n performs unicast communication in the same time symbols as those in which base station #m performs MBS communication that is frequency-division-multiplexed with unicast communication. Mobile stations MS (A, B, C, D, E, and F), each serving as the OFDM receiver 12, are connected to base station #n to perform unicast communication. Since mobile station MS (B) is closest in distance to the boundary of an area covered by base station #m, interference signals are not sufficiently attenuated by distance. As a result, reception performance of a unicast signal from base station #n, the unicast signal being a desired reception signal, may be degraded.

A method of solving this problem by performing scheduling for MBS transmission will now be described.

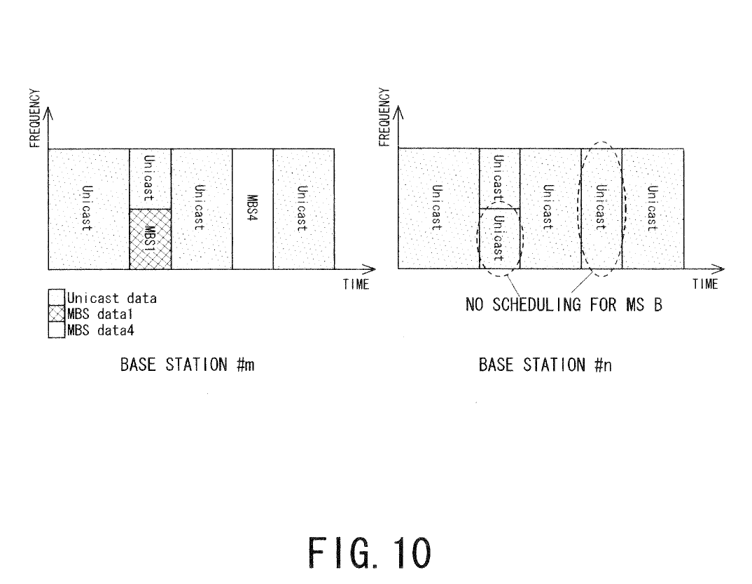

FIG. 10 illustrates how scheduling is performed at base stations #m and #n serving as the OFDM transmitters 11. Base station #m notifies, in advance, an adjacent base station (e.g., base station #n) via the MBS control station (and via the MBS database) of physical resources (frequency-time resources) to be used in MBS transmission. Base station #n does not allocate frequency-time resources to be used in MBS communication by base station #m to mobile station MS (B) that is close in distance to base station #m as resources for unicast communication.

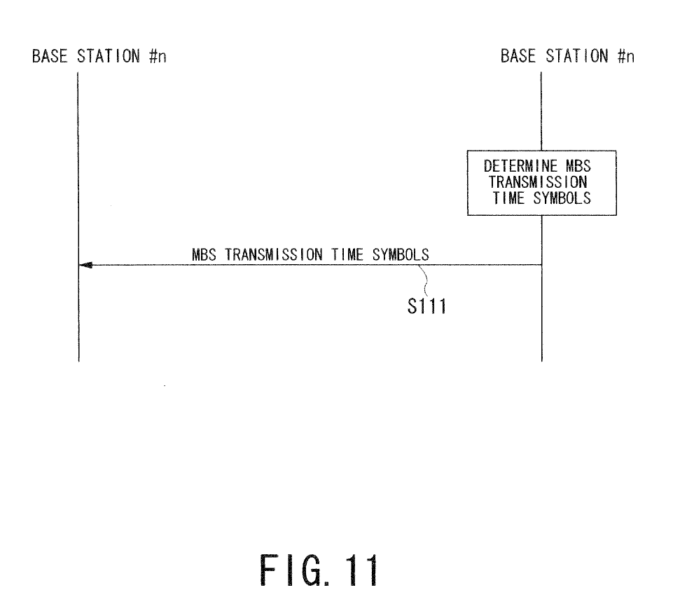

FIG. 11 illustrates a process flow between an MBS control station serving as the OFDM transmitter control station 10 and base station #n serving as the OFDM transmitter 11 and controlled by the MBS control station. As illustrated in FIG. 11, in step S111, the MBS control station notifies base station #n of MBS transmission time symbols and physical resources to be used in MBA communication.

Thus, even if a cell adjacent to a multicast/broadcast service area boosts transmission power in MBS communication, it is possible to avoid the effect of interference on unicast communication outside the multicast/broadcast service area, and mobile station MS present in an area covered by a base station adjacent to the multicast/broadcast service area can ensure necessary reception quality.

If it is difficult to detect locations of all mobile stations MS with which base station #n communicates, base station #n may obtain distances to mobile stations MS on the basis of quality information of reception signals reported by mobile stations MS. Then, frequency-time resources to be used for MBS communication may be scheduled only for mobile stations MS (D, E, and F) close in distance from base station #n.

The present invention is not limited solely to the embodiments described above. In the practical phase, the present invention can be embodied by modifying its components within its scope. It is possible to form various inventions by appropriately combining a plurality of components disclosed in the above embodiments. Some of the components described in the above embodiments may be omitted. Components according to different embodiments of the present invention may be appropriately combined.

The series of processes described in the embodiments of the present invention may be executed either by software or hardware.

The embodiments of the present invention have shown some examples where the steps of the flowcharts are processed sequentially in the described order. However, the steps of the flowcharts do not necessarily need to be processed sequentially, but may be processed simultaneously or individually.

What is claimed is:

1. A communication processing system comprising:
an OFDM transmitter; and
one or plural control stations configured to provide the same service area including a plurality of OFDM transmitters which are close or substantially the same in cell size,
wherein the one or plural control stations transmit first data, second data, and time symbol information to all the OFDM transmitters included in the same service area, receive transmission power margins from the respective OFDM transmitters included in the same service area, determine a transmission power boost value on the basis of the received transmission power margins, and transmit the determined transmission power boost value to all the OFDM transmitters included in the same service area; and
each of the OFDM transmitters included in the same service area receives the first data, the second data, and the time symbol information from the one or plural control stations, calculates a transmission power margin in a time symbol cased on the time symbol information from the control station, transmits the calculated transmission power margin to the control station, receives a transmission power boost value from the control station, multiplies a data channel signal corresponding to the first data by the received transmission power boost value, generates, in the time symbol based on the time symbol information, an OFDM signal in which a macro diversity signal corresponding to the first data and a non-macro diversity signal corresponding to the second data are frequency-division-multiplexed, and outputs the generated OFDM signal to an OFDM receiver.

2. One communication processing system according to claim 1, wherein the control station transmits, to an OFDM transmitter adjacent to the OFDM transmitters included in the same service area, the time symbol information and information related to a physical resource to be used for transmitting the first data.

3. An OFDM signal transmitting method of an OFDM transmitter included in a service area, the OFDM signal transmitting method comprising:
a data channel signal generating step of generating a data channel signal including at least one of a first data channel signal and a second data channel signal by modulating a bit string obtained by channel coding;
a pilot channel signal generating step of generating a pilot channel signal;
an assigning step of assigning the pilot channel signal generated in the pilot channel signal generating step and the data channel signal generated in the data channel signal generating step to a pilot subcarrier and a data subcarrier, respectively;
a scrambling step of multiplying the pilot channel signal and the first data channel signal assigned to the pilot subcarrier and the data subcarrier, respectively, by a predetermined scrambling code orthogonal or near-orthogonal among service areas and unique to each service area, and multiplying the second data channel signal assigned to the data subcarrier by a predetermined scrambling code orthogonal or near-orthogonal among OFDM transmitters and unique to each OFDM transmitter;
a transmission power boost step of multiplying, if the first data channel signal is included in the data channel signal, the first data channel signal multiplied by the scrambling code in the scrambling step by a transmission power boost value notified in advance from one or more control stations which control OFDM transmitters included in the same service area to all the OFDM transmitters included in the same service area;
an OFDM signal generating step of generating, in a time symbol based on time symbol information from one of the one or more control stations, an OFDM signal by OFDM-modulating the pilot channel signal and the second data channel signal multiplied by the scrambling codes in the scrambling step and the first data channel signal multiplied by the transmission power boost value in the transmission power boost step, the OFDM signal being a signal in which a macro diversity signal corresponding to the first data channel signal and a non-macro diversity signal corresponding to she second data channel signal are frequency-division-multiplexed; and
a transmitting step of transmitting the OFDM signal generated in the OFDM signal generating step to an OFDM receiver via an antenna.

4. The OFDM signal transmitting method according to claim 3, wherein the first data channel signal is assigned to a subcarrier corresponding to a physical resource notified in advance from one of the one or more control stations which control the OFDM transmitters included in the same service area.

5. The OFDM signal transmitting method according to claim 4, wherein the physical resource is the same for all the OFDM transmitters included in the same service area.

6. The OFDM signal transmitting method according to claim 3, wherein the pilot channel signal used for channel estimation of the first data channel signal is the same as or different from the pilot channel signal used for channel estimation of the second data channel signal.

7. The OFDM signal transmitting method according to claim 3, wherein the first data channel signal is an MBS data channel signal and the second data channel signal is a unicast date channel signal.

8. The OFDM signal transmitting method according to claim 3, wherein the transmission power boost value is a coefficient relative to transmission power of the OFDM signal corresponding to the second data channel signal.

9. An OFDM transmitter included in a service area, the OFDM transmitter comprising:
a data channel signal generating unit configured to generate a data channel signal including at least one of a first data channel signal and a second data channel signal by modulating a bit string obtained by channel coding;
a pilot channel signal generating unit configured to generate a pilot channel signal;
an assigning unit configured to assign the pilot channel signal generated by the pilot channel signal generating unit and the data channel signal generated by the data channel signal generating unit to a pilot subcarrier and a data subcarrier, respectively;
a scrambling unit configured to multiply the pilot channel signal and the first data channel signal assigned to the pilot subcarrier and tire data subcarrier, respectively, by a predetermined scrambling code orthogonal or near-orthogonal among service areas and unique to each service area, and multiply the second data channel signal assigned to the data subcarrier by a predetermined scrambling code orthogonal or near-orthogonal among OFDM transmitters and unique to each OFDM transmitter;
a transmission power boost unit configured to multiply, if the first data channel signal is included in the data channel signal, the first data channel signal multiplied by the scrambling code by the scrambling unit by a transmission bower boost value notified in advance from one or more control stations which control OFDM transmitters included in the same service area to all the OFDM transmitters included in the same service area;
an OFDM signal generating unit configured to generate, in a time symbol based on time symbol information from one of the one or more control stations, an OFDM signal by OFDM-modulating the pilot channel signal and the second data channel signal multiplied by the scrambling codes by the scrambling unit and the first data channel signal multiplied by the transmission power boost value by the transmission power boost unit, the OFDM signal being a signal in which a macro diversity signal corresponding to the first data channel signal and a non-macro diversity signal corresponding to the second data channel signal are frequency-division-multiplexed; and
a transmitting unit configured to transmit the OFDM signal generated by the OFDM signal generating unit to an OFDM receiver via an antenna.

10. The OFDM transmitter according to claim 9, wherein the assigning unit assigns the first data channel signal to a subcarrier corresponding to a physical resource notified in advance from one of the one or more control stations which control the OFDM transmitters included in the same service area.

11. The OFDM transmitter according to claim 10, wherein the physical resource is the same for all the OFDM transmitters included in the same service area.

12. The OFDM transmitter according to claim 9, wherein the pilot channel signal used for channel estimation of the first data channel signal is the same as or different from the pilot channel signal used for channel estimation of the second data channel signal.

13. The OFDM transmitter according to claim 9, wherein the first data channel signal is an MBS data channel signal and the second data channel signal is a unicast data channel signal.

14. The OFDM transmitter according to claim 9, wherein the transmission power boost value is a coefficient relative to transmission power of the OFDM signal corresponding to the second data channel signal.

15. An OFDM receiver comprising:
a receiving unit configured to receive an OFDM signal transmitted from an OFDM transmitter included in a service area;
an OFDM demodulation unit configured to OFDM-demodulate the OFDM signal received by the receiving unit into signals for respective subcarriers;
a separating unit configured to separate, from the signals obtained by the OFDM demodulation unit, a pilot channel signal and a data channel signal assigned to the respective subcarriers;
a descrambling unit configured to descramble, by using a scrambling code unique to the service area, the pilot channel signal separated by the separating unit and a first data channel signal included in the data channel signal separated by the separating unit, and descramble, by using a scrambling code unique to the OFDM transmitter, a second data channel signal included in the data channel signal separated by the separating unit;
a transmission power deboost unit configured to multiply the first data channel signal descrambled by the descrambling unit by a reciprocal of a transmission power boost value notified in advance to all OFDM transmitters included in the same service area;
a channel estimation unit configured to perform channel estimation on the data channel signal separated by the separating unit, on the basis of the pilot channel signal separated by the separating unit;
an equalizing unit configured to equalize, by using a channel estimate obtained by the channel estimation unit, the second data channel signal descrambled by the descrambling unit and the first data channel signal multiplied by the reciprocal of the transmission power boost value by the transmission power deboost unit; and
a data demodulating unit configured to demodulate the first data channel signal and the second data channel signal equalized by the equalizing unit.

16. A control station providing a service area including a plurality of OFDM transmitters which are close or substantially the same in cell size, the control station comprising:
a data transmitting unit configured to transmit first data, second data, and time symbol information to all the OFDM transmitters included in the same service area;
a receiving unit configured to receive transmission power margins from the respective OFDM transmitters included in the same service area;
a determining unit configured to determine a transmission power boost value on the basis of the transmission power margins received by the receiving unit; and
a transmission power boost value transmitting unit configured to transmit the transmission power boost value determined by the determining unit to al the OFDM transmitters included in the same service area.

17. The control station according to claim 16, further comprising a physical resource transmitting unit configured to transmit, to all the OFDM transmitters included in the same service area, information related to a physical resource to be used for transmitting the first data.

18. The control station according to claim 17, wherein the physical resource transmitting unit transmits, to an OFDM transmitter adjacent to the OFDM transmitters included in the same service area, the time symbol information and the information related to the physical resource to be used for transmitting the first data.
